(19) United States
(12) Patent Application Publication
(10) Pub. No.: US 2026/0251265 A1
(43) Pub. Date: Aug. 27, 2026

(54) PROCESS FOR STORING AND EXPLOITING A FIRST GAS AND A SECOND GAS DENSER THAN THE FIRST GAS IN AN AQUIFER OR DEPLETED RESERVOIR

(71) Applicant: STORENGY, Bois Colombes (FR)

(72) Inventors: Patrick EGERMANN, Cahors (FR); Christophe RENIER, Paris (FR); Emmanuel KERMARREC, Paris (FR); Delphine PATRIARCHE, Cachan (FR)

(21) Appl. No.: 18/879,429

(22) PCT Filed: Jun. 28, 2023
(86) PCT No.: PCT/FR2023/050987

§ 371 Date: Dec. 27, 2024

(30) Foreign Application Priority Data
Jun. 29, 2022 (FR) 2206507

(51) Int. Cl. F17C 1/00; B65G 5/00; F17C 5/00

(52) U.S. Cl. CPC F17C 1/007; B65G 5/00; F17C 5/00; F17C 2221/012; F17C 2221/033; F17C 2270/0155

(57) ABSTRACT

A process for storing and exploiting a first gas and a second gas denser than the first gas in an aquifer or depleted reservoir, by means of an installation includes: a first well opening into an upper part of the reservoir and connected to a network for transporting the first gas, a second well opening into a lower part of the reservoir and connected to a network for transporting the second gas. The process includes storing the first gas in the upper part of the reservoir, storing the second gas in the lower part of the reservoir, exploiting the first gas by the first well, and exploiting the second gas by the second well. The exploitation of the first gas can be implemented simultaneously and separately from the exploitation of the second gas.

### TECHNICAL FIELD

The present invention relates to the storage and exploitation of gas in underground reservoirs, in particular storage in aquifers or depleted reservoirs. The invention finds particular application in the storage of dihydrogen.

### PRIOR ART

Underground gas storage reservoirs are known as aquifers, in which the reservoir has a substantially dome shape, composed of porous rock in which the gas is stored. The gas is held in the reservoir by an impermeable layer that defines this dome shape and the roof of the reservoir (the impermeable layer can be called cap rock), and by water that defines the bottom of the storage. Also known are reservoirs called depleted reservoirs, having the same structure as aquifers but which initially contained hydrocarbons (gas or oil) with a little water and not just water.

These reservoirs are conventionally used to store natural gas. However, there is a need to store other types of gas, particularly dihydrogen, in underground reservoirs. Indeed, the production of dihydrogen is set to increase, and surface storage of dihydrogen is limited in terms of volume.

The storage of dihydrogen in porous/permeable media, and the use of wells to inject and withdraw gas is known from the document “Enabling large-scale hydrogen storage in porous media-the scientific challenges” (Heinemann N. et al., 2021, Energy Environ. Sci., 2021, 14, 853-864.).

The storage of dihydrogen in porous media nevertheless has difficulties because of reaction mechanisms which can occur due to interactions between the water in the aquifer and the rock, these interactions being known in particular from document “Overview of available test results and regulatory limits for Hydrogen admission into existing natural gas infrastructure and end use” (Marcogaz Technical Association of the European Natural Gas Industry, 2019).

In particular, two types of reactions are known:
abiotic reactions, which appear when interactions occur with the rock according to geochemical imbalances following the introduction of dihydrogen (and its dissolution in water) but also of their kinetics (a very slow reaction rate with little industrial impact in the end), and
biotic reactions, which appear when the interactions originate from the development of anaerobic bacteria present in the environment and feeding, among other things, on dihydrogen dissolved in the water. These reactions can lead to changes in the chemistry of the water (for example in pH) which can induce secondary abiotic reactions.

These reactions can have an impact on the quality of the withdrawn gas (for example because they lead to the formation of hydrogen sulfide (H2S). They can also have an impact on the efficiency of the storage since dihydrogen can be consumed. Finally, these reactions affect the performance of the storage since the reactions can modify the petrophysical properties of the reservoir if the permeability of certain parts of the reservoir is degraded in a non-reversible way.

Methods are known for characterizing the reaction risks associated with the introduction of dihydrogen into a porous reservoir, but they require the implementation of complex characterization and validation steps which neither allow the risks to be completely eliminated nor allow progress to be made quickly enough to develop an industrial project.

In particular, the upstream risk estimates are known:
use can be made of statistical studies conducted on bacterial populations sampled in various hydrocarbon deposits and storage areas (Strobel G., Hagemann B., Huppertz T.M., Ganzer L.: “Underground bio-methanation: Concept and potential”, Renewable and Sustainable Energy Reviews, 123, 2020; or Thaysen E.M. et al, 2021, Hydrogen Storage in Porous Media as a Basis for Site Selection, Renewable and Sustainable Energy Reviews, Preprint 5) to qualify the upstream risk of biotic reactions taking into account the features of the site studied (in particular its temperature and water composition),
use can be made of geochemical simulation tools based on the information known on the site studied to qualify the risk of abiotic reactions, according to methods known from the following documents:
   Truche, L., Jodin-Caumon M.-C., Lerouge C., Berger G., Mosser-Ruck R., Giffaut E., Michau D., 2013, Sulphide mineral reactions in clay-rich rock induced by high hydrogen pressure. Application to disturbed or natural settings up to 250° C. and 30 bar, Chemical Geology 351 (2013) 217-228,
   Thüns N., Krooss B.M., Zhang Q., Stanjek H., 2019, The effect of H2 pressure on the reduction kinetics of hematite at low temperatures, International Journal of Hydrogen Energy 44 (2019) 27615-27625,
   Shi Z. et al, 2020, Impacts of the subsurface storage of natural gas and hydrogen mixtures, International Journal of Hydrogen Energy 45 (2020) 8757-8773, and
   Ziegler L., 2021, H2_ReacT-Transport of hydrogen in rocks considering abiotic chemical and microbial redox reactions, presentation at the Underground Sun Conversion Stakeholder Workshop, April 14th, 2021.

Laboratory characterization methods are also known:
For example, if the conditions of a site correspond to a risk zone, sampling of reservoir rocks, formation water but also bacterial fauna can be implemented, which requires a dedicated protocol (biological samples).
Reactions can be evaluated in the laboratory via experiments in reservoir conditions with the targeted fluids and pieces of rock in autoclaves previously sterilized then seeded with bacterial cultures from representative biological samples. These experiments allow to identify the predominant reactions as well as their kinetics (Ranchou-Peyruse M. et al, 2019, Geological gas storage shapes deep life, Environmental Microbiology (2019) 21(10), 3953-3964). It can be noted that the induced evolutions in terms of porosity and permeability are still the subject of very early R&D developments and cannot be directly deduced from this type of experiment (Ott H., 2021, BioPore—Motivation, Project and Findings, presentation at the Underground Sun Conversion Stakeholder Workshop, April 14th, 2021). Thus, this constitutes an additional source of uncertainty.

Also reservoir-scale characterizations and simulations are known:
For example, once this laboratory characterization step has been carried out, it becomes possible to initiate the development of a compositional and reaction model and to carry out initial assessments at the reservoir scale.
At this stage, it is also recommended to size then implement a pilot operation on site on a sufficiently large scale in order to collect the data necessary to validate the reservoir model scaling steps. Validating this step is essential in order to find the right compromise between the calculation time (number of cells) and the good representation of geological heterogeneities in a context where the number of mechanisms to be taken into account is high, all with a 3D geometry.

While natural gas storage is known, the storage of other gases such as dihydrogen remains difficult. For example, the storage of dihydrogen has specific risks.

Currently, the storage of dihydrogen in saline cavities is known. The storage of dihydrogen in porous reservoirs remains at the study and validation stage, without any industrial project being under development.

That being said, current studies have confirmed that such storage in porous reservoirs is feasible with controlled risks, but only under particularly favorable conditions which limit the cases in which storage is feasible: low activity of the aquifer, temperature comprised between 25 and 50° C., water composition without sulphates, mineralogy without pyrites or iron oxides.

Current solutions for storing gases such as dihydrogen are therefore particularly limited, due to the risk of reaction of dihydrogen in the subsoil which could lead to a degradation of the quality of the gas when withdrawn, a loss of a significant fraction of the stored dihydrogen, and finally a reduction in the permeability of the reservoir induced by biotic and/or abiotic reactions.

The invention aims at solving at least some of the aforementioned disadvantages.

### DISCLOSURE OF THE INVENTION

To this end, the invention proposes a process for storing and exploiting a first gas and a second gas denser than the first gas in an aquifer or depleted reservoir, by means of an installation comprising:
a first well (optionally one or more first wells) opening into an upper part of the reservoir and connected to a network for transporting the first gas,
a second well (optionally one or more second wells) opening into a lower part of the reservoir (the upper part being above the lower part) and connected to a network for transporting the second gas,
the process comprising storing the first gas in the upper part of the reservoir, storing the second gas in the lower part of the reservoir, exploiting the first gas by the first well, and exploiting the second gas by the second well, the exploitation of the first being able to be implemented simultaneously and separately from the exploitation of the second gas.

The invention therefore proposes to exploit, that is to say inject or withdraw gas, two distinct gases via two different wells but which open onto the same reservoir. This exploitation can be implemented simultaneously and separately, which means that the first gas can be withdrawn/injected while the second gas is withdrawn/injected. Furthermore, the first gas can be injected/withdrawn while no withdrawal/injection action is implemented on the second gas (typically it is stored), and the second gas can be injected/withdrawn while no withdrawal/injection action is implemented on the first gas (typically it is stored), although in this case there is a gas which is not exploited strictly speaking (it is stored). In other words, the exploitation of the first gas is implemented independently of the exploitation of the second gas.

As an indication and without limitation, a single underground reservoir can be operated for two gases, in a manner corresponding to an exploitation on two completely independent underground storage reservoirs, each corresponding to one of the gases, and being connected to their respective transport networks and treatment workshops. This feature is particularly important, in a context where the storage needs of new gases are increasing, with the use of specific transport networks, while still needing storage for the gases used historically, and where underground reservoirs suitable for storage are few.

In fact and for information purposes, for each gas, there can be a treatment workshop between the reservoir and the gas transport network (there can therefore be two treatment workshops for two different gases stored for their two separate networks). A gas treatment workshop can implement dehydration and desulfurization of the gas, for example. These simultaneous and separate operations are for example implemented for a given domain of volumes of the first gas and the second gas. This given domain can be a given distribution of volumes, so that a given non-zero volume of the first gas (for example comprised in a range of volumes) and a given non-zero volume of the second gas in the reservoir (for example comprised in a range of volumes) are always maintained.

Due to the difference in density between the two gases and the targeted injection mode, the two gases remain separated inside the reservoir in the vertical direction, and the person skilled in the art will be able to determine the depth at which the wells open to obtain this configuration, depending in particular on the volumes to be stored.

It may be noted that the concept of volume is used in the present application. Of course, these volumes are at the pressure at which the gases are stored in a reservoir, that is to say at a pressure adapted for this reservoir, which the person skilled in the art will be able to determine. This adapted pressure is that which is effective for the gas at the depth of the reservoir for its storage.

It has therefore been observed that it is possible to store and exploit two different gases independently in the subsoil.

Furthermore, it may be noted that if the first gas is a gas that may be involved in aqueous phase reactions that could affect its storage and operation (in terms of gas quality, lost energy, reduction in permeability/porosity), the first gas is here separated from the mobile, and therefore the most reactive, water at the bottom of the storage due to the presence of the second gas between the first gas and the water. The invention thus improves the storage of at least the first gas, if this gas participates in aqueous phase reactions that degrade its storage.

According to a particular implementation, the first gas is dihydrogen.

The invention is particularly well suited for a first gas less dense than the second which is dihydrogen. This results from the fact that the second denser gas, which is in the lower part, is the one which will be in contact with the water of the aquifer (or of the depleted reservoir).

However, the reactions which have an impact on the storage of dihydrogen generally occur in the aqueous phase after a dissolution of a part of the dihydrogen in the water (it can be noted that the pressure and the temperature, as well as the movements of the aquifer induced by the storage activity can affect the storage), which is limited by the presence of the second gas between the first gas and the water at the bottom of the reservoir which thus acts as a buffer to limit the undesirable reactions.

According to a particular implementation, the second is natural gas.

Natural gas storage as a second gas is particularly well suited to be the gas that will interface with the water at the bottom of the reservoir, natural gas storage in aquifer or in depleted reservoir being well controlled. Furthermore, natural gas is well suited when dihydrogen is the primary gas.

According to a particular embodiment, the exploitation of the first gas includes an exploitation of a single volume called useful volume of the first gas, the process including a step of defining the useful volume of the first gas, the total volume of the first gas in the reservoir being equal to the sum of the useful volume of the first gas with a volume called cushion volume (or cushion gas) of the first gas located at the interface with the second gas.

Thus, in this particular implementation, the exploitation of the first gas is limited so as to always maintain a volume of first gas which will not be withdrawn for example (the cushion volume), and which is located at the interface with the second. This allows to exploit only a portion of good quality (for example in terms of composition) of the first gas, because the cushion volume can include second gas which diffuses towards the first gas.

For example, the cushion volume can be fixed. The useful volume can be defined as a range of volumes.

According to a particular embodiment, the exploitation of the second gas includes an exploitation of a single volume called the useful volume of the second gas, the process including a step of defining the useful volume of the second gas, the total volume of the second gas in the reservoir being equal to the sum of the useful volume of the second gas with a volume called the upper cushion of the second gas located at the interface with the first gas and another volume called the lower cushion of the second gas located below the useful volume of the second gas (in particular in the interface zone with the water).

In this particular implementation, the exploitation of the second gas is limited so as to always maintain two volumes of the second gas that are not withdrawn (the two cushion volumes), which are respectively located at the interface with the first gas (or even the cushion volume of the first gas) and with the water in the reservoir. This allows to exploit only a portion of good quality (for example in terms of composition) of the second gas, because the cushion volumes may include first gas that diffuses towards the second gas, or be affected by contact with water.

According to a particular implementation, the steps of defining the useful volume of the first gas and the useful volume of the second gas are carried out during a preliminary phase in which observation data of the operation of the reservoir and a modeling of the reservoir are used.

This phase can be carried out prior to the storage and independent exploitation of the first and second gases, for example when the reservoir includes only one type of gas (for example the second gas).

According to a particular implementation, the observation data of the operation of the reservoir are obtained by tracer tests or by observation data of the successive exploitation of different gases in the reservoir.

According to a particular implementation, the process comprises an update of the useful volume of the first gas and of the useful volume of the second gas taking into account observation data of the exploitation of the first gas or of the exploitation of the second gas.

This update may involve a change in the cushion volumes used, to maintain good quality of the withdrawn gas. For example, if the second gas is detected in the withdrawal of the first gas with a concentration above a target concentration value, the cushion volume of the first gas can be increased.

According to a particular implementation, a third gas denser than the second gas is stored between the second gas and the water in the reservoir.

This third gas can be used as a cushion gas at the interface with water.

According to one implementation, the reservoir initially includes only the second gas, or, if the process includes the storage of the third gas, only the third gas.

This implementation is particularly well suited to the storage of the first gas, for example dihydrogen, in a reservoir initially used to store natural gas (the second gas).

The invention also proposes an installation for storing and exploiting a first gas and a second gas denser than the first gas in an aquifer or depleted reservoir, comprising:
a first well (optionally one or more first wells) opening into an upper part of the reservoir and connected to a network for transporting the first gas,
a second well (optionally one or more first wells) opening into a lower part of the reservoir and connected to a network for transporting the second gas,
the installation being configured to allow storage of the first gas in the upper part of the reservoir, storage of the second gas in the lower part of the reservoir, exploitation of the first gas by the first well, and exploitation of the second gas by the second well, the exploitation of the first gas being able to be implemented simultaneously and separately from the exploitation of the second gas.

This installation can be configured to implement all the implementations the process as defined above.

### BRIEF DESCRIPTION OF THE DRAWINGS

Other features and advantages of the present invention will emerge from the description given below, with reference to the appended drawings which illustrate an exemplary embodiment thereof without any limiting character. In the figures:

FIG. 1 is a schematic representation of an installation according to one example.

FIG. 2 is a schematic representation of an installation according to another example.

FIG. 3 is a schematic representation of an installation according to another example.

FIG. 4 is a schematic representation of the distribution of volumes according to one example.

FIG. 5 illustrates the steps of a process according to one example.

FIG. 6 illustrates a numerical modeling of the volume concentration of natural gas at different storage periods according to one example.

FIG. 7 illustrates the modeled evolutions of the fraction of dihydrogen produced in the upper and lower parts of the reservoir according to one example.

FIG. 8 is a schematic representation of an installation.

### DESCRIPTION OF THE EMBODIMENTS

Storage and exploitation processes for two distinct gases, and the installations used to implement these storages will now be described.

In the present description, the storages are aquifer reservoirs or depleted reservoirs (aquifers initially containing hydrocarbons (gas or oil), with for example an aquifer which can have a variable activity, in which the reservoir has substantially a dome shape, composed of porous rock in which the gas is stored. The gas is maintained in the reservoir by an impermeable layer which defines this dome shape and the roof of the reservoir (the impermeable layer can be called cap rock), and by liquid water which defines the bottom of the storage area.

The invention finds application in the storage and exploitation of a low density gas which can possibly react in the aqueous phase (for example after dissolution in water), which it facilitates by additionally storing a second denser gas between the first gas and the water in the reservoir.

In the present description, the first gas is dihydrogen and the second gas is natural gas. Other first gases may be used and other second gases may be used, for example helium (H2) as the first gas with nitrogen (N2) as the second gas may be used.

For dihydrogen, storing and exploiting this gas in an aquifer or depleted reservoir is delicate due to the (abiotic, biotic) reactions that have an impact on the storage and exploitation performances (in particular in terms of gas quality, energy lost, and reduction of permeability/porosity). It has been observed that these reactions generally occur in the aqueous phase after dissolution of a part of the dihydrogen gas in water. As is understood, pressure and temperature also have an impact on these reactions, as does transport via aquifer movements induced by storage and exploitation activity.

To limit the impact of these reactions, a second gas denser than dihydrogen is used to act as a cushion and separate the dihydrogen from the aqueous phase. Thus, for any type of aquifer or depleted reservoir, the risks of loss of quality, lost energy, and reduction in permeability/porosity can be limited.

Since natural gas has a marginal reaction potential, it has become apparent that it can be used as a cushion gas compared to dihydrogen. Furthermore, if a well opens into the lower part of the reservoir where the natural gas will be stored, it can further be exploited independently.

As can be understood, when a reservoir is already used to store natural gas (it initially contains mainly methane), this gas can be used as a second gas and therefore as a cushion gas compared to the first gas which is dihydrogen.

For a first filling (a reservoir that initially contains water), other gases can be used, such as nitrogen as a second gas. In fact, the second gas can be chosen to be denser than the first depending on the chemical reactions in which it participates in the aqueous phase. Furthermore, the second gas can be chosen so that it does not introduce induced risks such as corrosion related to the introduction of carbon dioxide or dioxygen accompanying the nitrogen.

As explained above, here two gases with different densities, that is to say two gases with different molar masses, are used. For example, dihydrogen and natural gas have a molar mass difference of the order of 14 grams per mole. This difference is even greater if a second gas such as nitrogen or carbon dioxide is used. It has been observed that a good separation of the two gases in the vertical direction is obtained with molar mass differences of the order of 12 grams per mole.

In addition to separation, here, there is also independent exploitation and storage of the two gases.

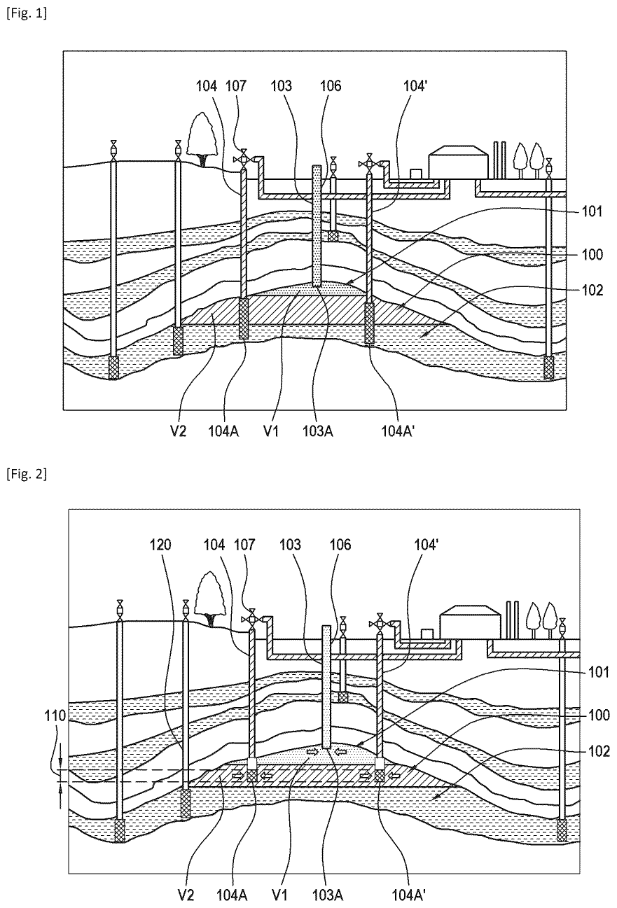

An example of an INS installation is shown in FIG. 1, where an aquifer reservoir 100 is seen in section (an identical installation is also conceivable for a depleted reservoir). This reservoir is limited in its upper part by an impermeable dome 101, and in its lower part by water 102. The part between the water and the dome is the one that will be called here reservoir, comprising the porous rock and which will accommodate gases.

In the installation of FIG. 1, a plurality of wells are provided. In particular, a first well 103 is provided in a central part of the reservoir, and this well opens into an upper part of the reservoir (its lower end 103A opens into this upper part). The invention is not limited to a single first well, and can be implemented by means of a plurality of first wells which open into the upper part.

A second well 104 is also provided in a peripheral part, to the left of the first well 103 in the figure, and this well opens into a lower part of the reservoir, located between the upper part and the bottom of the reservoir (its lower end 104A opens into this lower part). Optionally, another second well 104′ is provided in a peripheral part, to the right of the first well 101, and this well opens into the lower part of the reservoir (its lower end 104A′ opens into the lower part). In fact, the invention is not limited to one or two second wells, and can be implemented by means of a plurality of second wells which open into the lower part.

It may be noted that the two second wells 104 and 104′ end in the reservoir by strainers 105 and 105′ in a manner known per se, which begin in the lower part and end here in the bottom of the reservoir.

The first well 103 is connected to a transport network 106 of a first gas which is here dihydrogen. The expression network here refers to a set of buried or non-buried pipes, capable of injecting dihydrogen through the first well 103 and capable of withdrawing dihydrogen through the first well 103.

The second well 104 is connected to a network 107 for transporting a second gas which is here natural gas.

If the reservoir 100 initially includes natural gas, it is possible, with the first well 103, to introduce dihydrogen into the upper part of the reservoir, while maintaining natural gas in the lower part of the reservoir. The introduction of dihydrogen leads to obtaining a volume V1 of dihydrogen stored in the reservoir, and to obtaining a volume V2 of natural gas stored in the reservoir. In the figure, the volume V1 actually designates the upper part of the reservoir occupied by this volume, and the volume V2 actually designates the lower part of the reservoir. These two parts are defined by the gases that compose them (as is understood, diffusion and dispersion are possible at the interface, however, the person skilled in the art will know how to delimit these two parts).

These two volumes are separated naturally due to the difference in density between the two gases. As illustrated in the figure, volume V1 is not in contact with the bottom of the reservoir and the liquid water, and which allows dihydrogen to be stored and used under optimal conditions.

As a result, it is possible to implement respective operations of dihydrogen and natural gas that are independent of each other. The person skilled in the art may in particular call this independent operation a co-activity.

To further improve the respective exploitation of the two gases, the diffusion which can occur at the interface between the two gases, and possibly at the interface with water can be taken into account.

Thus, in FIG. 2, another installation is shown (but in which the references of FIG. 1 are reused to designate the same elements), in which the openings of the second wells 104 and 104′, at the strainers 105 and 105′, differ from those of FIG. 1 since some are plugged to delimit a depth range 110 in which the natural gas can circulate. Thus, natural gas that is not affected by the presence of dihydrogen or water is withdrawn, which can have an impact on the quality of the operation.

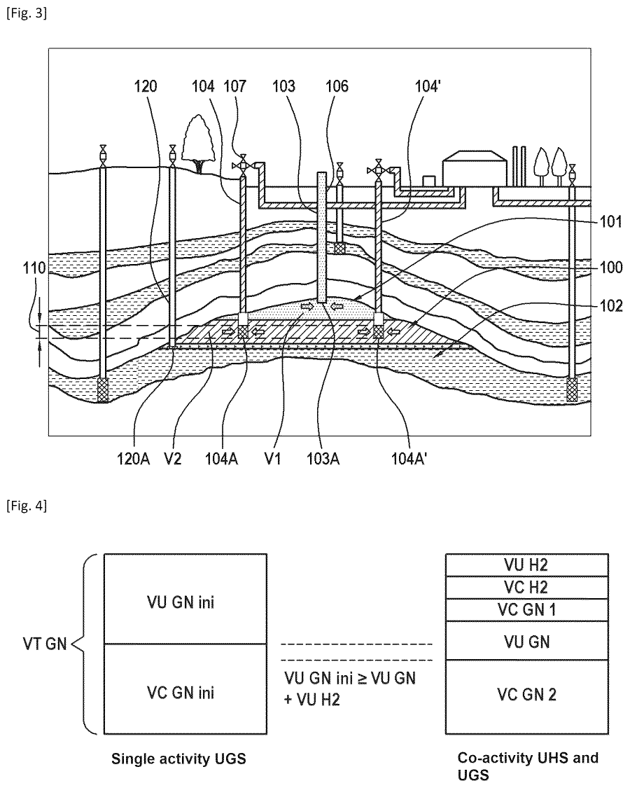

In FIG. 3, yet another installation is shown, which differs from that of FIGS. 1 and 2 in that a third well 120 is provided, opening at the periphery of the reservoir towards the bottom of the reservoir (its end 120A arrives a little before the bottom and far below the ends of the second wells).

This installation allows a third gas, typically an inert gas such as nitrogen, to be injected into the bottom of the reservoir, so that the water does not affect the production of natural gas in any way.

In the embodiments of FIGS. 2 and 3, volumes called cushion volumes are used. This is further detailed with reference to FIG. 4.

In this figure, on the left side there is a schematic representation of the distribution of natural gas in an aquifer reservoir that includes only natural gas. Thus, the reference VT_GN designates the total volume of natural gas in this reservoir, VU_GN_ini a useful volume of natural gas in this reservoir, and VC_GN_ini a cushion volume of natural gas in this reservoir.

Here, a useful volume is a volume that can be withdrawn/injected, while a cushion volume is a volume that is not intended to be withdrawn/injected.

On the left side of the figure, there is a schematic representation of the distribution of gases in a reservoir such as that of FIG. 2, with two different gases and cushion volumes. Starting from the bottom of the reservoir, we have:
a lower cushion volume VC_GN_2 of natural gas, at the interface with the water,
a useful volume VU_GN of natural gas (including natural gas with a good level of purity), this volume being at the openings of FIG. 2,
an upper cushion volume VC_GN_1 of natural gas (comprising mainly methane),
a cushion volume VC_H2 of dihydrogen (comprising mainly dihydrogen),
a useful volume VU_H2 of dihydrogen (comprising dihydrogen with a good level of purity).

It can be noted that between the cushion volumes VC_GN_1 and VC_H2, a gradient of the concentration of dihydrogen, which increases in the direction of the surface is observed.

As an indication, an aquifer reservoir initially comprising natural gas type gas with a useful volume of 690 Mm³ and a cushion volume of 810 Mm³ can be considered. If it is desired to use this reservoir to store and exploit dihydrogen, a useful volume of 200 Mm³ of dihydrogen (corresponding to 16820 tons at a given pressure) can be chosen as an indication. To avoid mixing between the gases, at least in the parts that will be exploited, it can be considered that 25% of the cushion gas (the sum of the cushion volumes) must consist of dihydrogen, which represents approximately 200 Mm³ for the 810 Mm³ of total cushion volume. This leads to obtaining a useful volume of 490 Mm³ of remaining natural gas. The use of the cushion volume comprising dihydrogen allows to avoid mixing between the two gases in the part called useful volume, and to obtain two real useful volumes. Moreover, the useful volume of natural gas is arranged, as can be seen in FIG. 4, between two cushion volumes.

It can be noted that the water seal (distance between the zone and the second gas withdrawal point) is modified compared to the initial configuration of the reservoir, this modification may be acceptable.

It is also noted that the ratio between the useful volume and the total volume is greater when the reservoir includes only one gas (natural gas), compared to when it includes two gases, if the same useful volume is kept for both gases as the useful volume of the initial single gas. If the total volume is kept constant in bottom conditions, the useful volume with two gases is reduced compared to the initial configuration with a single gas because the water seal for the natural gas is then reduced by the need to place part of the cushion gas of the natural gas in the upper part (VC_GN_1). It can be noted that the concept of water seal is well known to the person skilled in the art and corresponds to the distance (possibly an elevation) to be respected between the lowest part of the well (here natural gas) and the water, to avoid sucking up water.

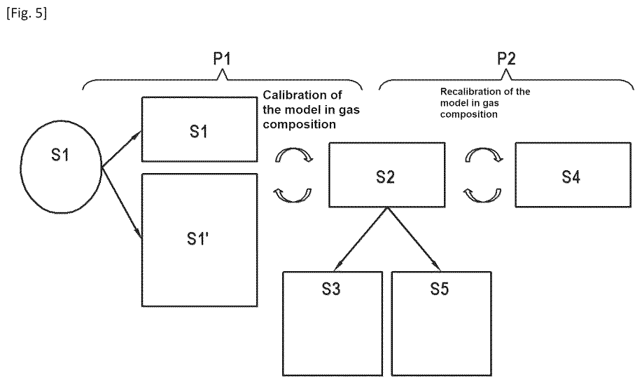

The way in which the volumes are defined, for example the volumes of FIG. 4 will now be described with reference to FIG. 5. These steps can be implemented on a computer. The first steps are steps implemented in an initial phase P1, which precedes the use of the reservoir for two gases.

An aquifer reservoir is considered, for example, a new reservoir (for example, which initially contains water) or a reservoir already exploited to store natural gas (as a second gas). In fact, the reservoir can be a reservoir according to the French standards NF EN 1918-1 or 2, in their versions of June 2016.

In a first step, observation data on the operation of the reservoir can be obtained.

This achievement can be implemented in two alternative ways, and it applies to both reservoirs already used and new reservoirs.

In step S1, tracer tests are implemented, in which an inert element (sometimes called a tracer) is added to the injected gas for a short period of time (typically, this injection is similar to a Dirac-type signal). A withdrawal is then implemented to analyze the gas and determine a concentration of the element that has been injected. Several measurements can be implemented regularly, and an evolution of the concentration in the form of a deformed Gaussian that illustrates the mixing between the tracer and a gas present in the reservoir, which results from diffusion and especially dispersion mechanisms.

Alternatively, step S1′ may be implemented in which observation data of the exploitation of gases stored and exploited in the reservoir are obtained. For example, if the reservoir has been used to successively store and exploit different gases with different compositions, the associated observation data of the exploitation may be used. In fact, these data may indicate an evolution of the composition of the gas over time, and are similar to the data obtained by implementing step S1.

In fact, in the present description, observation data may be curves of concentration of a gas as a function of time.

Then, step S2 can be implemented in which a reservoir model is used that is calibrated using the data obtained in steps S1 or S1′. More precisely, a reservoir model can be used that simulates the dynamic gas flows, the gas transport mechanisms as well as the physicochemical reaction mechanisms between the gases, the water and the rock; this allows to simulate the composition of the gas that will be withdrawn at a given location/depth in the storage. There are various known solutions for modeling a storage. Indeed, there are several commercial or academic codes capable of simulating at least the compositional mechanisms of gas mixing. Examples that are not exhaustive include ECLIPSE 300 marketed by the company SCHLUMBERGER or STARS marketed by the Canadian company COMPUTER MODELLING GROUP LTD, as possible commercial codes. The HYTEC code developed by Ecole des Mines de Paris is also known.

This model can, thanks to said calibration, reflect the heterogeneities of the reservoir in the composition values that it delivers.

Step S3 of sizing the reservoir can then be implemented, in which, using the model, the useful volumes and usable cushions are determined for the reservoir (for example to have a given level of purity for the useful volumes).

For example, for storage and exploitation of natural gas and dihydrogen, this step may include the determination of the volumes VC_GN_2, VU_GN, VC_GN_1, VH_H2, and VU_H2 described above.

The model also allows to determine the flow rates to be used for exploitation, etc. Furthermore, the uncertainties inherent in a subsoil model can be taken into account, in order to obtain good independent exploitation of the two gases.

These steps are implemented during phase P1 which precedes the storage and exploitation of the two gases.

In the reservoir exploitation phase P2, during the independent exploitation of the two gases, a step S4 can be implemented in which exploitation observation data of the two gases are obtained in a manner similar to what was implemented in phase P1 in step S1′. It is thus possible to observe the evolutions in the composition of the withdrawn gases, as a function of time and the different volumes present in the reservoir, and the different flow rates used.

In this step S4, it is possible to compare the observed data with those obtained in the initial phase, which allows to recalibrate (step S5) the model with new parameters, and then to determine new volumes and flow rates for the reservoir.

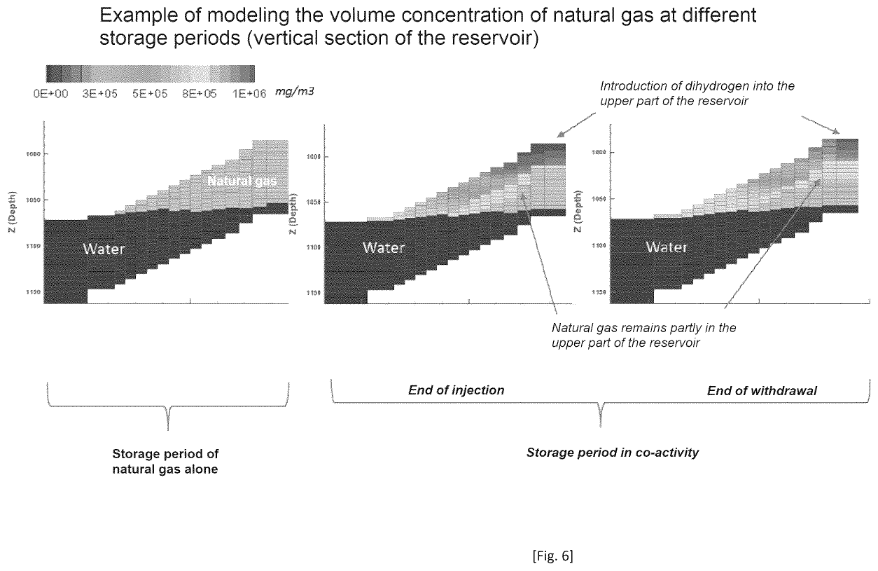

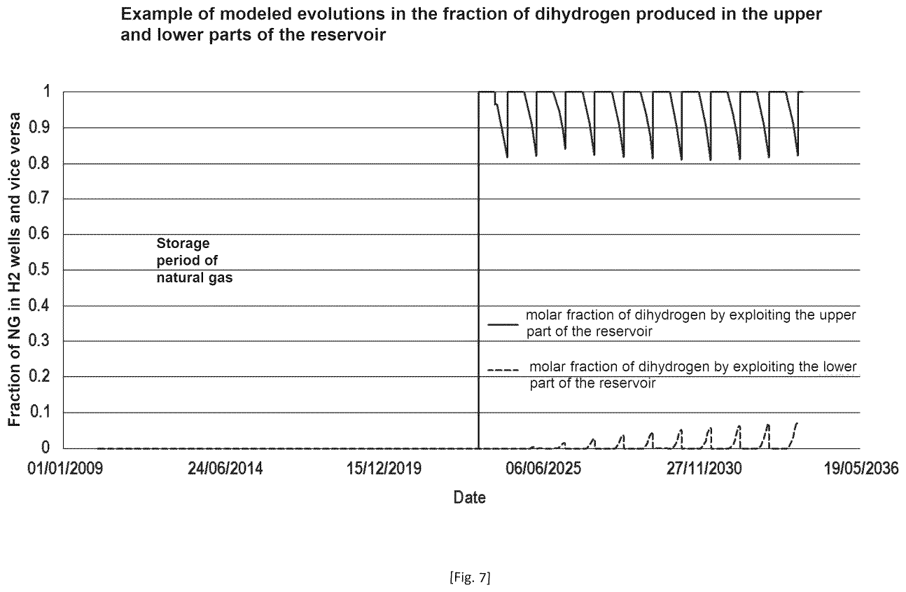

FIG. 6 shows three graphical representations of numerical modeling of the volume concentration of natural gas in a reservoir into which dihydrogen is to be injected and which initially contained natural gas. The three representations correspond to vertical sections of a portion of the reservoir since the volume concentration of natural gas can be seen in a horizontal direction, from the edge of the reservoir to its center, and in a vertical direction, from the bottom of the reservoir (where water is present) to the top of the reservoir.

In the left graphic representation, the reservoir includes only natural gas above the water. The middle representation corresponds to the introduction of dihydrogen in the upper part of the reservoir (more precisely to the situation at the end of dihydrogen injection), and it can be seen that the concentration of natural gas decreases in this part. The representation on the right corresponds to the situation after a dihydrogen withdrawal, the modeling clearly shows that even after a withdrawal, there is always a low concentration of natural gas in the upper part of the reservoir.

FIG. 7 shows a modeling of the evolution over time of the fraction of dihydrogen produced (what is obtained during a withdrawal), both in the upper part of a reservoir and in the lower part (by two separate wells), after the introduction of dihydrogen into a reservoir initially containing natural gas.

As can be seen, after the introduction of dihydrogen, there is still a molar fraction of dihydrogen in the upper part that is above 80% (the lowest values correspond to the end of the withdrawal phases). In the lower part of the reservoir, the molar fraction of dihydrogen remains below 10%, which can be acceptable for applications.

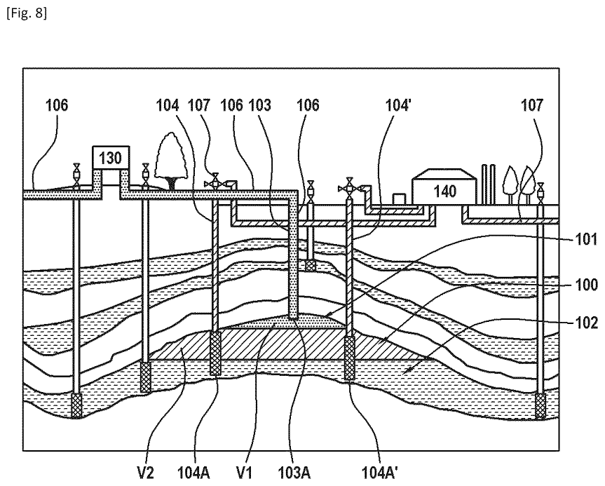

FIG. 8 shows an installation similar to that of FIG. 1, which is non-limiting and provided as an example, in which the transport networks of the first gas and the second gas have been made more visible.

More specifically, the transport network 106 of the first gas and the transport network 107 of the second gas are more completely shown here.

Within the transport network of the first gas, a first gas treatment workshop 130 is shown, for example used to implement dehydration and desulfurization of the first gas.

A treatment workshop 140 of the second gas is also referenced in the figure, this workshop being arranged within the transport network of the second gas. Also, this treatment workshop is for example used to implement dehydration and desulfurization of the second gas.

The installations and processes described above allow to store and exploit two gases independently, to the extent that these two gases have different densities.

It is thus possible to withdraw a first gas while the second gas is injected or withdrawn or just stored, to inject the first gas while the second gas is injected or withdrawn or just stored. It is also possible to withdraw the second gas while the first gas is injected or withdrawn or just stored, to inject the second gas while the first gas is injected or withdrawn or just stored.

This is well suited for storing hydrogen along with natural gas, given that natural gas storage cycles are seasonal, and hydrogen storage cycles can be faster.

1.-11. (canceled)

12. A process for storing and exploiting a first gas and a second gas denser than the first gas in an aquifer or depleted reservoir, by means of an installation comprising:
a first well opening into an upper part of the reservoir and connected to a network for transporting the first gas,
a second well opening into a lower part of the reservoir and connected to a network for transporting the second gas,
the process comprising storing the first gas in the upper part of the reservoir, storing the second gas in the lower part of the reservoir, exploiting the first gas by the first well, and exploiting the second gas by the second well, the exploitation of the first gas being able to be implemented simultaneously and separately from the exploitation of the second gas.

13. The process according to claim 12, wherein the first gas is dihydrogen.

14. The process according to claim 12, wherein the second is natural gas.

15. The process according to claim 12, wherein the exploitation of the first gas includes an exploitation of a single volume called useful volume of the first gas, the process including a step of defining the useful volume of the first gas, the total volume of the first gas in the reservoir being equal to the sum of the useful volume of the first gas with a volume called cushion volume of the first gas located at the interface with the second gas.

16. The process according claim 12, wherein the exploitation of the second gas includes an exploitation of a single volume called the useful volume of the second gas, the process including a step of defining the useful volume of the second gas, the total volume of the second gas in the reservoir being equal to the sum of the useful volume of the second gas with a volume called the upper cushion of the second gas located at the interface with the first gas and another volume called the lower cushion of the second gas located below the useful volume of the second gas.

17. The process according to claim 15, wherein the steps of defining the useful volume of the first gas and the useful volume of the second gas are carried out during a preliminary phase in which observation data of the operation of the reservoir and a modeling of the reservoir are used.

18. The process according to claim 17, wherein the observation data of the operation of the reservoir are obtained by tracer tests or by observation data of the successive exploitation of different gases in the reservoir.

19. The process according to claim 17, comprising an update of the useful volume of the first gas and of the useful volume of the second gas taking into account observation data of the exploitation of the first gas or of the exploitation of the second gas.

20. The process according to claim 12, wherein a third gas denser than the second gas is stored between the second gas and the water in the reservoir.

21. A process according to claim 20, wherein the reservoir initially includes only the second gas, or, only the third gas.

22. An installation for storing and exploiting a first gas and a second gas denser than the first gas in an aquifer or depleted reservoir, comprising:
a first well opening into an upper part of the reservoir and connected to a network for transporting the first gas,
a second well opening into a lower part of the reservoir and connected to a network for transporting the second gas,
the installation being configured to allow storage of the first gas in the upper part of the reservoir, storage of the second gas in the lower part of the reservoir, exploitation of the first gas by the first well, and exploitation of the second gas by the second well, the exploitation of the first gas being able to be implemented simultaneously and separately from the exploitation of the second gas.
